(19) United States
(12) Patent Application Publication
(10) Pub. No.: US 2003/0043849 A1
(43) Pub. Date: Mar. 6, 2003

(54) UTOPIA INTERFACE CONTROL DEVICE AND METHOD, AND BACK WIRING BOARD FOR USE IN UTOPIA INTERFACE CONTROL DEVICE

(75) Inventor: Shinichi Suwa, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Tokyo (JP)

(21) Appl. No.: 10/060,201

(22) Filed: Feb. 1, 2002

(30) Foreign Application Priority Data
Aug. 29, 2001 (JP) 2001-259991

(51) Int. Cl. H04J 3/24

(52) U.S. Cl. 370/474

(57) ABSTRACT

A UTOPIA (Universal test and operations PHY interface for ATM) interface control device for connecting an Asynchronous Transfer Mode (ATM) layer function to a physical (PHY) layer function at UTOPIA level 2 is provided. The device comprises N groups of 32 PHY layer functions disposed according to a number of UTOPIA addresses, a unit connected between the ATM layer function and the N groups of 32 PHY layer functions, for allowing the ATM layer function to simultaneously deliver a UTOPIA address to the N groups of 32 PHY layer functions, a unit connected between the ATM layer function and each of the N groups of PHY layer functions, for allowing each of the N groups of 32 PHY layer functions to deliver a cell available signal to the ATM layer function, and a unit connected between the ATM layer function and each of the N groups of 32 PHY layer functions, for allowing the ATM layer function to deliver an enable signal to each of the N groups of 32 PHY layer functions.

### BACKGROUND OF THE INVENTION

1. Field of the Invention

The present invention relates to a UTOPIA (Universal test and operations PHY interface for ATM) interface control device for and method of connecting an Asynchronous Transfer Mode (ATM) layer function to a plurality of physical (PHY) layer functions by using a UTOPIA interface. It also relates to a back wiring board for use in the UTOPIA interface control device.

2. Description of the Prior Art

The ATM forum has provided requirements which UTOPIA interfaces (UTOPIA level 2 interfaces) meet as a method of connecting an ATM layer function (referred to as ATM function from here on) to a plurality of PHY layer functions (referred to as PHY functions from here on).

FIG. 4 is a diagram showing connections between an ATM layer function and a plurality of PHY layer functions in accordance with a prior art UTOPIA interface control system. In the figure, reference numeral 40 denotes an ATM function, and reference numeral 41 denotes a subscriber interface. This UTOPIA interface control method provides a UTOPIA address signal (5 bits), a cell available signal, an enable signal, data (8/16 bits), and a clock, and can perform sending and receiving of ATM cells for 32 or less PHY functions (#00 to #31 in the figure) in the subscriber interface.

With reference to a sequence diagram of FIG. 5, a method of transferring cells (ATM data) from the ATM function to the subscriber interface by using the above-mentioned UTOPIA interface control system will be explained.

1. The ATM function transmits (polling) a UTOPIA address to specify a PHY function number (#00, . . . , or #31) to the plurality of PHY functions of the subscriber interface.

2. A specified PHY function transmits a cell available signal (Tx cell available) indicating notification of receive availability of cells to the ATM function.

3. The ATM function asserts an enable signal (Tx enable) and transmits cells which can be output to the PHY function specified by the PHY function number which has transmitted the cell available signal.

Thus, in the prior art UTOPIA interface control system constructed as mentioned above, the interface between the ATM function and the plurality of PHY functions is defined as an interface between 1 component and 32 components. Furthermore, no requirement is set for QoS (Quality of Service) control and so on.

A problem with the prior art UTOPIA interface control system is therefore that only 32 or less PHY functions can be connected to one ATM function, and, in the example as shown in the figure, the ATM function can be connected only to a certain single subscriber interface 41. Furthermore, another problem is that when connecting a PHY function with a PHY number which is the same as an existing PHY number to one ATM function, it is necessary to change the PHY number so that the PHY number should not be equal to any one of existing PHY numbers, in other words, any PHY function with a PHY number which is the same as an existing PHY number cannot be connected in parallel, and it is therefore impossible to increase the number of PHY functions which can be connected to one ATM function.

### SUMMARY OF THE INVENTION

The present invention is proposed to solve the above-mentioned problems, and it is therefore an object of the present invention to provide a UTOPIA interface control device with a simple structure and UTOPIA interface control method capable of connecting an increased number of PHY functions to an ATM function.

It is another object of the present invention to provide a back wiring board for use in UTOPIA interface control devices, in which wiring that constitutes a UTOPIA interface can be reduced.

In accordance with an aspect of the present invention, there is provided a UTOPIA interface control method of connecting an ATM layer function to a PHY layer function at UTOPIA level 2, the method comprising the steps of: disposing N groups of 32 physical layer functions according to a number of UTOPIA addresses; simultaneously controlling transmission of a UTOPIA address between the ATM layer function and the N groups of 32 PHY layer functions; individually controlling transmission of a cell available signal between the ATM layer function and each of the N groups of 32 PHY layer functions; and individually controlling transmission of an enable signal between the ATM layer function and each of the N groups of 32 PHY layer functions. Accordingly, the UTOPIA interface control method can control transmission of cells between the ATM layer function and the N groups of 32 PHY layer functions.

In accordance with another aspect of the present invention, there is provided a UTOPIA interface control device for connecting an ATM layer function to a PHY layer function at UTOPIA level 2, the device comprising: N groups of 32 PHY layer functions disposed according to a number of UTOPIA addresses; a unit connected between the ATM layer function and the N groups of 32 PHY layer functions, for allowing the ATM layer function to simultaneously deliver a UTOPIA address to the N groups of 32 PHY layer functions; a unit connected between the ATM layer function and each of the N groups of PHY layer functions, for allowing each of the N groups of 32 PHY layer functions to deliver a cell available signal to the ATM layer function; and a unit connected between the ATM layer function and each of the N groups of 32 PHY layer functions, for allowing the ATM layer function to deliver an enable signal to each of the N groups of 32 PHY layer functions. Accordingly, the UTOPIA interface control device can control transmission of cells between the ATM layer function and the N groups of 32 PHY layer functions. In addition, the UTOPIA interface control device can connect two or more PHY layer functions with the same UTOPIA address to the ATM layer function.

In accordance with a further aspect of the present invention, the ATM layer function has a priority processing function of performing predetermined priority processing in QoS classes when transmitting cells, and includes a transmission order determination unit for assigning priorities to the N groups of 32 PHY layer functions so as to, when two or more of the N groups of 32 PHY layer functions assert their cell available signals with an identical UTOPIA address, give a higher priority to transmission of cells to ones of the two or more groups of 32 PHY layer functions which will receive constant bit rate (CBR) traffic than to transmission of cells to a remainder of the two or more groups of 32 PHY layer functions which will receive unspecified bit rate (UBR) traffic. Accordingly, the UTOPIA interface control device can perform optimum QoS control operations on CBR and UBR traffic. Especially, the UTOPIA interface control device can perform transmission of cells associated with CBR traffic with stability, thereby making it possible for network resources to function with a high degree of efficiency.

In accordance with another aspect of the present invention, the ATM layer function has a priority processing function of performing predetermined priority processing in QoS classes when transmitting cells, and includes a transmission unit for, when two or more of the N groups of 32 PHY layer functions assert their cell available signals with an identical UTOPIA address and cells to be transmitted to the two or more groups of PHY layer functions are associated with such identical traffic as CBR or UBR traffic, transmitting cells to the two or more groups of PHY layer functions in rotation in order of descending priorities assigned to them in advance. Accordingly, the UTOPIA interface control device can smoothly transmit cells to the N groups of 32 PHY layer functions according to the priorities assigned to them with stability, thereby making it possible for network resources to function with a high degree of efficiency.

In accordance with a further aspect of the present invention, numbers indicating priority which decreases in ascending order of numbers are assigned to the N groups of 32 PHY layer functions, and the transmission unit transmits cells to the two or more groups of 32 PHY layer functions in rotation according to the numbers.

In accordance with another aspect of the present invention, numbers indicating priority which increases in ascending order of numbers are assigned to the N groups of 32 PHY layer functions, and the transmission unit transmits cells to the two or more groups of 32 PHY layer functions in rotation according to the numbers.

In accordance with an aspect of the present invention, there is provided a back wiring board for use in a UTOPIA interface control device for connecting an ATM layer function to a PHY layer function at UTOPIA level 2, the back wiring board comprising: a line connected between the ATM layer function and N groups of 32 PHY layer functions disposed according to a number of UTOPIA addresses, for allowing the ATM layer function to simultaneously deliver a UTOPIA address to the N groups of 32 PHY layer functions; a line connected between the ATM layer function and the N groups of 32 PHY layer functions, for allowing the ATM layer function to simultaneously deliver data to the N groups of 32 PHY layer functions; a line connected between the ATM layer function and each of the N groups of 32 PHY layer functions, for allowing each of the N groups of 32 PHY layer functions to deliver a cell available signal to the ATM layer function; and a line connected between the ATM layer function and each of the N groups of 32 PHY layer functions, for allowing the ATM layer function to deliver an enable signal to each of the N groups of 32 PHY layer functions. Accordingly, wiring disposed in the back wiring board can be reduced, thereby saving time required for wiring and reducing the manufacturing cost of the back wiring board.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a UTOPIA interface control device according to a first embodiment of the present invention;

FIG. 2 is a sequence diagram showing sending and receiving of cells in the UTOPIA interface control device according to the first embodiment;

FIG. 3 is a diagram showing a back wiring board according to a second embodiment of the present invention;

FIG. 4 is a diagram showing connections between an ATM layer function and a plurality of PHY layer functions in a prior art UTOPIA interface control system; and

FIG. 5 is a sequence diagram showing sending and receiving of cells in the prior art UTOPIA interface control system.

### DETAILED DESCRIPTION OF THE PREFERRED EMBODIMENTS

### Embodiment 1

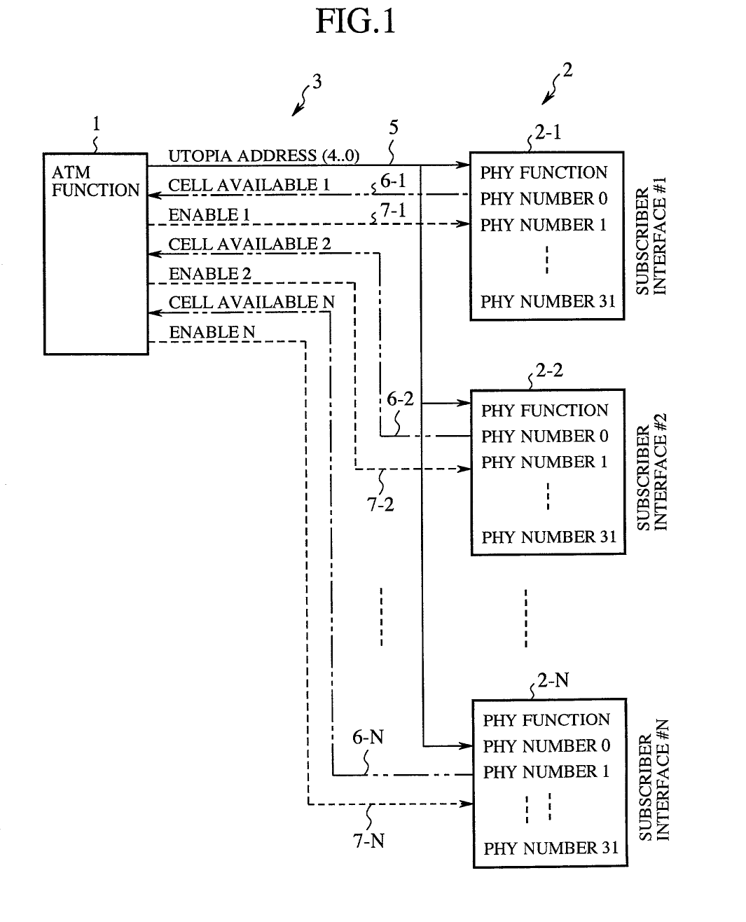

FIG. 1 is a block diagram showing a UTOPIA interface control device according to a first embodiment of the present invention. In the figure, reference numeral 1 denotes an ATM function, reference numeral 2 denotes a subscriber interface, and reference numeral 3 denotes a UTOPIA level 2 interface. N subscriber interface groups 2 are disposed. Each of the N subscriber interface groups 2-1 to 2-N has 32 PHY functions numbered 0 to 31. The ATM function 1 is connected to each of the plurality of subscriber interfaces 2 by way of the UTOPIA level 2 interface 3 (referred to as UTOPIA-I/F from here on).

In the UTOPIA-I/F 3,

\mathring{1} N enable signals and N cell available signals are provided for the N subscriber interfaces 2-1 to 2-N, respectively.

\mathring{2} In polling, 5 wires intended for UTOPIA addresses and N wires intended for enable/cell available signals are used to connect the ATM function 1 to the 32×N PHY functions for sending and receiving of cells between the ATM function 1 and the 32×N PHY functions.

In other words, when a 5-bit (0 to 4 bits) line is used for transmission of UTOPIA addresses and a 13-bit (0 to 12 bits) line is used for transmission of each of enable/cell available signals in the UTOPIA-I/F 3, an expansion slot handling up to 192 PHY functions (N=6 and N×32=192) can be supported and UTOPIA interface control can be performed between one ATM function 1 and 192 PHY functions 2.

As shown in the figure, the UTOPIA-I/F 3 sends and receives a UTOPIA address between the ATM function 1 and each of the plurality of subscriber interfaces 2-1 to 2-N by way of a common line 5. Furthermore, the UTOPIA-I/F 3 can transmit a cell available signal between each of the plurality of subscriber interfaces 2-1 to 2-N and the ATM function 1 by way of an individual control line 6 (6-1, . . . , or 6-N). The UTOPIA-I/F 3 can also transmit an enable signal between the ATM function 1 and each of the plurality of subscriber interfaces 2-1 to 2-N by way of an individual control line 7 (7-1, . . . , or 7-N).

In addition, the ATM function 1 has a priority processing function of performing priority processing at the time of transmission of cells. In other words, when two or more of the plurality of subscriber interfaces 2-1 to 2-N have the same UTOPIA address which has been set by the priority processing in QoS classes (CBR (constant bit rate service for audio data and so on) and UBR (unspecified bit rate service for data including images and soon) traffic classes) and assert their cell available signals, the ATM function 1 gives a higher priority to the transmission of cells to subscriber interfaces 2 which will receive CBR traffic. This is because in the case of transmission of audio data the conveyance of information cannot be done properly even if no more than a little part of the audio data is omitted, as compared with the case of transmission of data including images. Therefore, the ATM function 1 is set to give a higher priority to the transmission of cells to every subscriber interface 2 which will receive CBR traffic (audio data). Furthermore, when two or more of the plurality of subscriber interfaces 2-1 to 2-N will receive the same CBR or UBR and they assert their cell available signals, the ATM function 1 is set to give a higher priority to one subscriber interface 2 (for example, the first subscriber interface 2-1 in the case where the two subscriber interfaces 2-1 and 2-2 assert their cell available signals) with a smaller group number and to transmit cells to it.

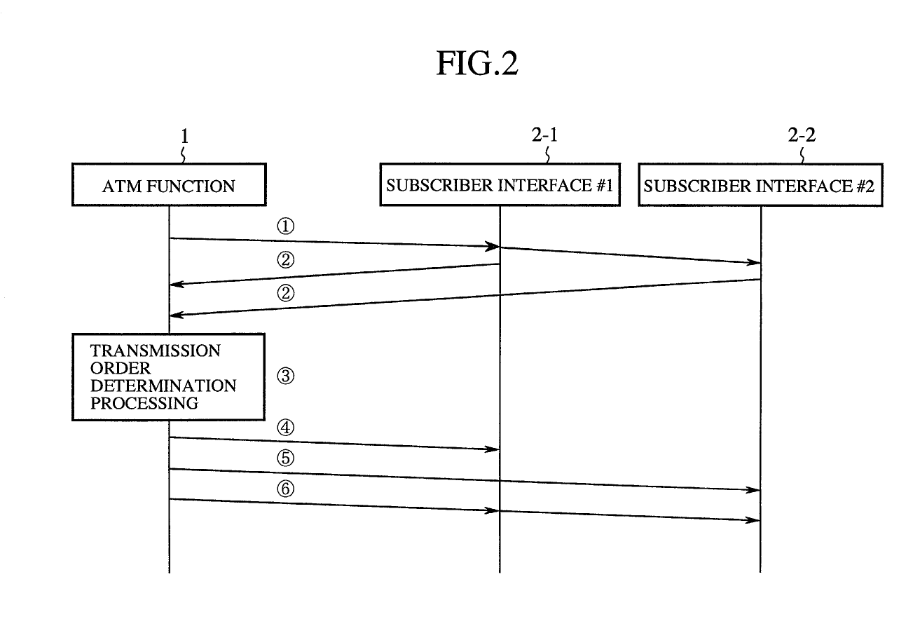

FIG. 2 is a sequence diagram showing an example of sending and receiving of cells in the UTOPIA interface control device with the above-mentioned structure. A procedure of transmitting cells from the ATM function 1 to the two interface groups (#1 and #2), i.e., the two subscriber interfaces 2-1 and 2-2 will be explained with reference to the figure.

\mathring{1} First of all, the ATM function 1 performs polling by sending out UTOPIA addresses (0 to 31) in rotation onto the common line 5 to address the two subscriber interfaces 2-1 and 2-2 (the two interface groups #1 and #2). In this case, all the addresses 0 to 31 are specified in one polling.

\mathring{2} Next, each of the two subscriber interfaces 2-1 and 2-2 asserts its cell available signal when it will receive cells from the ATM function 1. As previously mentioned, two cell available signals 1 and 2 are provided for the two subscriber interfaces 2-1 and 2-2 (two group numbers #1 and #2), respectively.

\mathring{3} The ATM function then performs the following sequential transmission processing.

As previously mentioned, the ATM function 1 performs priority processing in QoS classes at the time of transmission of cells. For example, when both the first subscriber interface 2-1 and the second subscriber interface 2-2 assert their cell available signals with the same UTOPIA address, if cells to be transmitted to the first subscriber interface 2-1 are associated with UBR traffic (data including images) and cells to be transmitted to the second subscriber interface 2-2 are associated with CBR traffic (audio data), the ATM function gives a higher priority to the transmission of cells to the second subscriber interface 2-2 which will receive CBR traffic.

Furthermore, when the two subscriber interfaces 2-1 and 2-2 which have been set in the same QoS class assert their cell available signals with the same UTOPIA address, the ATM function 1 gives a higher priority to the first subscriber interface 2-1 (group #1) with a smaller group number and to transmit cells to it. For example, when cells to be transmitted to the two subscriber interfaces 2-1 to 2-2 are both associated with UBR or CBR traffic, the ATM function 1 gives a higher priority to the first subscriber interface 2-1 (group #1) with a smaller group number. While priorities are assigned to the plurality of subscriber interfaces 2-1 to 2-N in advance, different priorities only have to be assigned to the plurality of subscriber interfaces 2-1 to 2-N. Thus the ATM function 1 can alternatively give a higher priority to a subscriber interface with a larger group number or a specific group number.

\mathring{4} The ATM function 1 then transmits cells to the two subscriber interfaces 2-1 and 2-2 in rotation in the order determined by the above-mentioned transmission order determination processing. For example, the ATM function 1 asserts the enable signal 1 and transmits cells to the first subscriber interface 2-1 when determined that the transmission of cells to the first subscriber interface 2-1 is given a higher priority.

\mathring{5} After completing the transmission of cells to the first subscriber interface 2-1, the ATM function 1 asserts the enable signal 2 and transmits cells to the second subscriber interface 2-2.

\mathring{6} Then the ATM function 1 starts polling previously explained in \mathring{1} again at the same time that the ATM function 1 starts the transmission of cells to one subscriber interface with the last subscriber interface number (the second subscriber interface 2-2 in the above-mentioned example) determined by the transmission order determination processing.

As mentioned above, in accordance with the first embodiment of the present invention, the UTOPIA interface control device can connect N groups of 32 PHY functions to an ATM function by using a UTOPIA level 2 interface without the constraint that the maximum number of PHY functions is 32. In addition, when two or more of the plurality of PHY function groups assert their cell available signals with the same UTOPIA address and cells to be transmitted to the two or more PHY function groups are associated with CBR traffic (audio) and UBR traffic (image) and, the ATM function 1 gives a higher priority to the transmission of cells to PHY function groups which will receive CBR traffic. Therefore, the UTOPIA interface control device can prevent omission of audio data during the transmission of CBR data and can perform the transmission of information with stability. Furthermore, when two or more of the plurality of PHY function groups simultaneously assert their cell available signals so as to acquire cells associated with the same traffic class CBR or UBR, the ATM function 1 gives a higher priority to one PHY function group with a smaller group number and transmits cells to it. Accordingly, the UTOPIA interface control device can perform QoS control at UTOPIA level 2 through the priority setting. Furthermore, the UTOPIA interface control device can perform the transmission of cells to each PHY function with stability and with a high degree of efficiency.

### Embodiment 2

In a UTOPIA-I/F 3 with a structure as previously explained in Embodiment 1, wiring can be implemented by using a backing wire board or BWB. The UTOPIA-I/F 3, which connects one above-mentioned ATM function 1 to a plurality of above-mentioned PHY functions 2, can be constructed of wiring on a single substrate, and is called BWB.

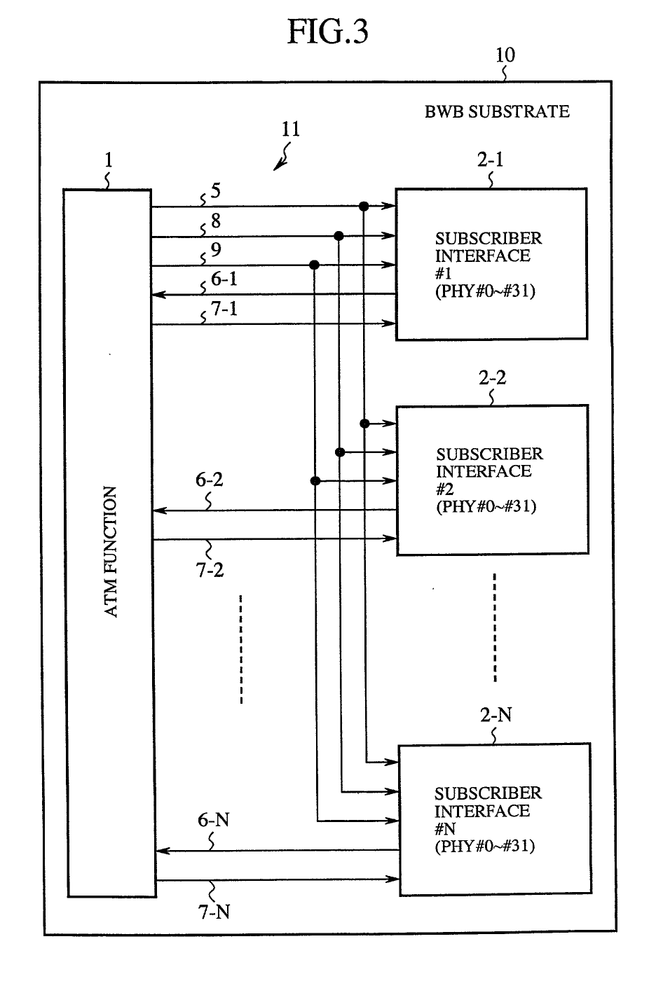

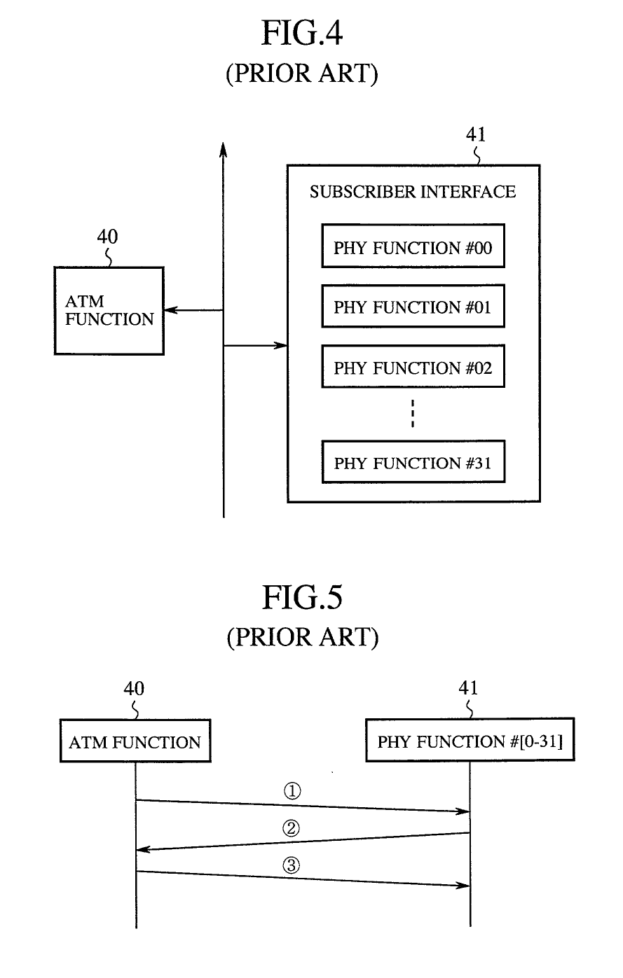

FIG. 3 is a diagram showing the structure of the BWB. Connection lines, which constitute the UTOPIA I/F 3, are formed of a printed circuit 11 on a BWB substrate 10. The printed circuit 11, which constitutes the UTOPIA-I/F 3 as explained in Embodiment 1, consists of a data line 8 for sending and receiving of cell data and an SOC (start of cell) line 9 in addition to a common line 5 for sending and receiving of UTOPIA addresses, control lines 6 for transmission of cell available signals, and control lines 7 for transmission of enable signals. For example, the common line 5 is used to send and receive 5-bit data, and the data line 8 is used to send and receive 8-bit data.

A control line 6 and a control line 7 are individually wired between the ATM function 1 and each of the plurality of subscriber interface functions 2, as mentioned above. The common line 5, the data line 8, and the SOC line 9 are connected in common (in parallel) between the ATM function 1 and the plurality of subscriber interface functions 2-1 to 2-N (groups #00 to #31).

As a result, only by using a set of control lines 6 and 7 which is individually wired only for sending and receiving of cell available/enable signals between the ATM function 1 and each of the plurality of subscriber interface functions 2, the UTOPIA interface control device can perform enhanced interface control operations on the increased number of PHY functions based on the same specification of UTOPIA level 2. In other words, the UTOPIA interface control device can address all subscriber interfaces 2-1 to 2-N and can perform data sending and receiving between all the subscriber interfaces 2-1 to 2-N and the ATM function 1 by way of the common line 5, the data line 8, and the SOC line 9 connected in common between all the subscriber interfaces 2-1 to 2-N and the ATM function 1. Since the common line 5, the data line 8, and the SOC line 9 are connected in common between all the subscriber interfaces 2-1 to 2-N and the ATM function 1, the number of those lines remains unchanged regardless of the increase in the number of groups of subscriber interfaces 2. Furthermore, it is essential only that the number of sets of control lines 6 and 7 is increased with the increase in the number N of groups of subscriber interfaces 2, and it is not necessary to individually wire a common line 5, a data line 8, and an SOC line 9 between each of the plurality of subscriber interfaces 2-1 to 2-N and the ATM function 1. It is therefore to possible to substantially reduce the number of lines in the printed circuit 11. This can result in a reduction in the manufacturing cost of the BWB board 10. The reduction in the number of lines in the printed circuit 11 is achieved on the assumption that polling or cell available/enable control is performed via each line mentioned above.

As mentioned above, in accordance with the second embodiment of the present invention, in the UTOPIA level 2 interface for connecting N groups of 32 PHY functions to one ATM function 1, it is essential only that a set of control lines is individually and additionally connected between each of the N groups of 32 PHY functions and the ATM function 1 according to the increase in the number of groups of 32 PHY functions, and it is therefore to possible to prevent increase in the number of lines in the printed circuit 11, thereby saving time required for wiring and reducing the manufacturing cost of the BWB board.

In the above-mentioned embodiments, it is assumed as concrete examples that there are provided 192 PHY functions, UTOPIA addresses are 5-bit binary numbers, and enable/cell available signals are 13-bit ones. As an alternative, the number of bits included in each UTOPIA address is increased and the number of bits included in each of the enable/cell available signals intended for each subscriber interface 2 is also increased, and a set of control lines 6 and 7 is individually wired between the ATM function 1 and each subscriber interface 2. Accordingly, the BWB can implement UTOPIA interface control by using a larger number of PHY functions.

Many widely different embodiments of the present invention may be constructed without departing from the spirit and scope of the present invention. It should be understood that the present invention is not limited to the specific embodiments described in the specification, except as defined in the appended claims.

What is claimed is:

1. A UTOPIA (Universal test and operations PHY interface for ATM) interface control method of connecting an Asynchronous Transfer Mode (ATM) layer function to a physical (PHY) layer function at UTOPIA level 2, said method comprising the steps of:
disposing N groups of 32 PHY layer functions according to a number of UTOPIA addresses;
simultaneously controlling transmission of a UTOPIA address between said ATM layer function and said N groups of 32 PHY layer functions;
individually controlling transmission of a cell available signal between said ATM layer function and each of said N groups of 32 PHY layer functions; and
individually controlling transmission of an enable signal between said ATM layer function and each of said N groups of 32 PHY layer functions.

2. A UTOPIA interface control device for connecting an ATM layer function to a PHY layer function at UTOPIA level 2, said device comprising:
N groups of 32 PHY layer functions disposed according to a number of UTOPIA addresses;
a means connected between said ATM layer function and said N groups of 32 PHY layer functions, for allowing said ATM layer function to simultaneously deliver a UTOPIA address to said N groups of 32 PHY layer functions;
a means connected between said ATM layer function and each of said N groups of PHY layer functions, for allowing each of said N groups of 32 PHY layer functions to deliver a cell available signal to said ATM layer function; and
a means connected between said ATM layer function and each of said N groups of 32 PHY layer functions, for allowing said ATM layer function to deliver an enable signal to each of said N groups of 32 PHY layer functions.

3. The UTOPIA interface control device according to claim 2, wherein said ATM layer function has a priority processing function of performing predetermined priority processing in Quality of Service (QoS) classes when transmitting cells, and includes a transmission order determination means for assigning priorities to said N groups of 32 PHY layer functions so as to, when two or more of said N groups of 32 PHY layer functions assert their cell available signals with an identical UTOPIA address, give a higher priority to transmission of cells to ones of said two or more groups of 32 PHY layer functions which will receive constant bit rate (CBR) traffic than to transmission of cells to a remainder of said two or more groups of 32 PHY layer functions which will receive unspecified bit rate (UBR) traffic.

4. The UTOPIA interface control device according to claim 2, wherein said ATM layer function has a priority processing function of performing predetermined priority processing in QoS classes when transmitting cells, and includes a transmission means for, when two or more of said N groups of 32 PHY layer functions assert their cell available signals with an identical UTOPIA address and cells to be transmitted to said two or more groups of PHY layer functions are associated with such identical traffic as CBR or UBR traffic, transmitting cells to said two or more groups of PHY layer functions in rotation in order of descending priorities assigned to them in advance.

5. The UTOPIA interface control device according to claim 4, wherein numbers indicating priority which decreases in ascending order of numbers are assigned to said N groups of 32 PHY layer functions, and said transmission means transmits cells to said two or more groups of 32 PHY layer functions in rotation according to the numbers.

6. The UTOPIA interface control device according to claim 4, wherein numbers indicating priority which increases in ascending order of numbers are assigned to said N groups of 32 PHY layer functions, and said transmission means transmits cells to said two or more groups of 32 PHY layer functions in rotation according to the numbers.

7. The UTOPIA interface control device according to claim 3, wherein said ATM layer function includes a transmission means for, when two or more of said N groups of 32 PHY layer functions assert their cell available signals with an identical UTOPIA address and cells to be transmitted to said two or more groups of PHY layer functions are associated with such identical traffic as CBR or UBR traffic, transmitting cells to said two or more groups of PHY layer functions in rotation in order of descending priorities assigned to them in advance.

8. The UTOPIA interface control device according to claim 7, wherein numbers indicating priority which decreases in ascending order of numbers are assigned to said N groups of 32 PHY layer functions, and said transmission means transmits cells to said two or more groups of 32 PHY layer functions in rotation according to the numbers.

9. The UTOPIA interface control device according to claim 7, wherein numbers indicating priority which increases in ascending order of numbers are assigned to said N groups of 32 PHY layer functions, and said transmission means transmits cells to said two or more groups of 32 PHY layer functions in rotation according to the numbers.

10. A back wiring board for use in a UTOPIA interface control device for connecting an ATM layer function to a PHY layer function at UTOPIA level 2, said back wiring board comprising:
a line connected between said ATM layer function and N groups of 32 PHY layer functions disposed according to a number of UTOPIA addresses, for allowing said ATM layer function to simultaneously deliver a UTOPIA address to said N groups of 32 PHY layer functions;
a line connected between said ATM layer function and said N groups of 32 PHY layer functions, for allowing said ATM layer function to simultaneously deliver data to said N groups of 32 PHY layer functions;
a line connected between said ATM layer function and each of said N groups of 32 PHY layer functions, for allowing each of said N groups of 32 PHY layer functions to deliver a cell available signal to said ATM layer function; and
a line connected between said ATM layer function and each of said N groups of 32 PHY layer functions, for allowing said ATM layer function to deliver an enable signal to each of said N groups of 32 PHY layer functions.
